(19) United States
(12) Patent Application Publication
(10) Pub. No.: US 2022/0011491 A1
(43) Pub. Date: Jan. 13, 2022

(54) OPTICAL FILM, RETARDER FILM, AND METHOD FOR MANUFACTURING SAME

(71) Applicant: ZEON CORPORATION, Chiyoda-ku, Tokyo (JP)

(72) Inventors: Kazuki KUMAZAWA, Tokyo (JP); Hironari SUDEJI, Tokyo (JP)

(73) Assignee: ZEON CORPORATION, Chiyoda-ku, Tokyo (JP)

(21) Appl. No.: 17/295,258

(22) PCT Filed: Nov. 8, 2019
(86) PCT No.: PCT/JP2019/044016

§ 371 Date: May 19, 2021

(30) Foreign Application Priority Data
Nov. 30, 2018 (JP) 2018-225551

(51) Int. Cl. G02B 5/30; C08F 297/04

(52) U.S. Cl. CPC G02B 5/3083; B29C 48/022; C08F 297/04

(57) ABSTRACT

An optical film formed of a resin C including a copolymer P containing a polymerization unit A and a polymerization unit B, wherein the optical film includes a phase separation structure that expresses structural birefringence, the phase separation structure includes a phase containing as a main component the polymerization unit A and a phase containing as a main component the polymerization unit B, and a value of Rth/d calculated from the thickness-direction retardation Rth (nm) and thickness d (nm) is 2.5×10-3 or more.

### FIELD

The present invention relates to an optical film, a phase difference film, and a method for producing the optical film and the phase difference film.

### BACKGROUND

In display devices such as liquid crystal display devices, optical films having various properties may be disposed for improving the display quality. Various optical films are under development. For example, optical films with optical anisotropy (Patent Literatures 1 and 3 to 5) and optical films with optical isotropy (Patent Literature 2) are developed.

### CITATION LIST

### Patent Literature

Patent Literature 1: Japanese Patent Application Laid-Open No. 2006-111650 A

Patent Literature 2: Japanese Patent Application Laid-Open No. 2006-142561 A

Patent Literature 3: Japanese Patent Application Laid-Open No. 2006-143799 A

Patent Literature 4: International Publication No. 2008/146924 (foreign publication corresponding thereto: U.S. Patent Application Publication No. 2010/283949)

Patent Literature 5: Japanese Patent Application Laid-Open No. Hei. 05-164920 A

### SUMMARY

### Technical Problem

For example, a phase difference film, disposed in display devices for the purpose of improving viewing angle properties such as viewing angle compensation and reflection suppression, is required to have an NZ factor of more than 0 and less than 1. Furthermore, the NZ factor is preferably 0.5 or close to 0.5. An example of the method for producing a phase difference film having such an NZ factor is a method of combining a large number of layers (Patent Literature 4). However, a phase difference film obtained by this method has a complicated structure, and therefore production thereof requires a high production cost, resulting in low productivity.

Regarding the phase difference films obtained by stretching the primary films disclosed in Patent Literatures 1 to 3 and the phase difference films disclosed in Patent Literature 5, effect of improving viewing angle properties is insufficient.

Therefore, there is a demand for an optical film from which a phase difference film having a sufficient effect of improving viewing angle properties can be produced at low cost, and a method for producing such an optical film.

### Solution to Problem

The present inventor intensively conducted research for solving the aforementioned problem. As a result, the present inventor has found that the aforementioned problem can be solved by an optical film having a specific phase separation structure and a specific Rth/d value. Thus, the present invention has been accomplished. Herein, Rth means the thickness-direction retardation (nm) of the film, and d (nm) means the thickness of the film.

That is, the present invention provides the following.

(1) An optical film formed of a resin C including a copolymer P containing a polymerization unit A and a polymerization unit B, wherein

the optical film includes a phase separation structure that expresses structural birefringence,

the phase separation structure includes a phase containing as a main component the polymerization unit A and a phase containing as a main component the polymerization unit B, and

a value of Rth/d calculated from the thickness-direction retardation Rth (nm) and thickness d (nm) is 2.5×10⁻³ or more.

(2) The optical film according to (1), wherein the value of Rth/d is 3.0×10⁻³ or more and 8.0×10⁻³ or less.

(3) The optical film according to (1) or (2), wherein the thickness d is 150 μm or less.

(4) The optical film according to any one of (1) to (3), wherein the phase separation structure has a configuration of any of lamella, cylinder, and spheroid.

(5) The optical film according to any one of (1) to (4), wherein a distance between phases in the phase separation structure is 200 nm or less.

(6) The optical film according to any one of (1) to (5), wherein the copolymer P is a block copolymer having a block (A) containing as a main component the polymerization unit A and a block (B) containing as a main component the polymerization unit B.

(7) The optical film according to any one of (1) to (6), wherein the polymerization unit A is a unit represented by the following general formula (A):

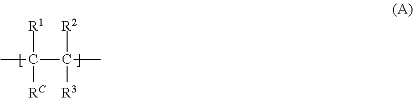

in the formula, R^{C} is a group selected from the group consisting of a phenyl group, a biphenylyl group, a naphthyl group, an anthracenyl group, a phenanthrenyl group, a naphthacenyl group, a pentacenyl group, and a terphenylyl group, and

R¹ to R³ are each independently one selected from the group consisting of a hydrogen atom and an alkyl group of 1 to 12 carbon atoms.

(8) The optical film according to (7), wherein a molar ratio of a polymerization unit HA, which is a hydrogenation product of the polymerization unit A, relative to the polymerization unit A in the copolymer P is 0/100 or more and 10/90 or less.

(9) The optical film according to any one of (1) to (8), wherein the polymerization unit B is a unit represented by the general formula (B-1) or a unit represented by the general formula (B-2):

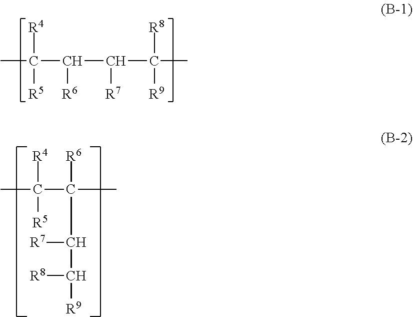

in the formula, R⁴ to R⁹ are each independently one selected from the group consisting of a hydrogen atom and an alkyl group of 1 to 6 carbon atoms.

(10) The optical film according to (9), wherein a total molar ratio of a unit represented by the following general formula (B′-1) and a unit represented by the following general formula (B′-2) relative to the polymerization unit B in the copolymer P is 0/100 or more and 10/90 or less:

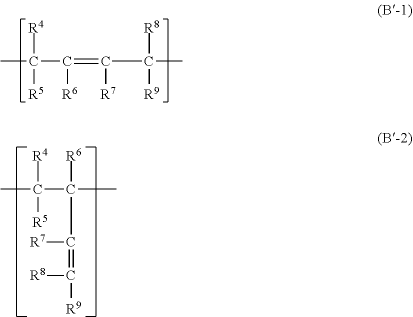

in the formula, R⁴ to R⁹ are the same definitions as those described above.

(11) The optical film according to any one of (1) to (10), wherein

the polymerization unit A is a vinylnaphthalene unit, a vinylnaphthalene derivative unit, a styrene unit, or a styrene derivative unit, and

the polymerization unit B is a unit that is a hydrogenation product of an isoprene unit, a unit that is a hydrogenation product of a butadiene unit, a unit that is a hydrogenation product of a 1,3-pentadiene unit, a unit that is a hydrogenation product of a 2,3-dimethyl-1,3-butadiene unit, a unit that is a hydrogenation product of a 1,3-hexadiene unit, a unit that is a hydrogenation product of a 2-methyl-1,3-pentadiene unit, a unit that is a hydrogenation product of a 3-methyl-1,3-pentadiene unit, or a unit that is a hydrogenation product of a 2,4-dimethyl-1,3-pentadiene unit.

(12) The optical film according to any one of (1) to (11), wherein

the copolymer P includes a triblock copolymer P′, and

the triblock copolymer P′ is a triblock copolymer of

(A)-(B)-(A) having a block (A) containing as a main component the polymerization unit A and a block (B) containing as a main component the polymerization unit B.

(13) The optical film according to any one of (1) to (12), wherein the copolymer P has a negative intrinsic birefringence value.

(14) The optical film according to any one of (1) to (13), wherein the polymerization unit A has a negative intrinsic birefringence value, and the polymerization unit B has a positive intrinsic birefringence value.

(15) The optical film according to any one of (1) to (14), wherein a weight fraction of the polymerization unit A in the copolymer P is 55% by weight or more and 75% by weight or less.

(16) A method for producing the optical film according to any one of (1) to (15), comprising the steps of:

heating the resin C at 150° C. or higher to form a single-layer film of the resin C; and

causing phase-separation of the resin C in the film.

(17) The method for producing the optical film according to (16), wherein the step of forming the film includes a step of press-molding the resin C.

(18) The method for producing the optical film according to (16), wherein the step of forming the film includes melt-extruding a single layer of the resin C.

(19) A method for producing a phase difference film comprising the step of stretching the optical film according to any one of (1) to (15) to obtain a phase difference film, a value of Re(E)/d(E) calculated from the in-plane retardation Re(E) (nm) and thickness d(E) (nm) of the phase difference film being 1.5×10⁻³ or more.

(20) The method for producing a phase difference film according to (19), wherein the optical film is produced by the method for producing the optical film according to any one of (16) to (18).

### Advantageous Effects of Invention

According to the present invention, there can be provided an optical film from which a phase difference film having a sufficient effect of viewing angle compensation can be produced at low cost, and a method for producing such an optical film.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a “long-length” film refers to a film with the length that is 5 times or more the width, and preferably a film with the length that is 10 times or more the width, and specifically refers to a film having a length that allows a film to be wound up into a rolled shape for storage or transportation. The upper limit of the length of the film is not particularly limited, and may be 100,000 times or less the width, for example.

In the following description, a “plate” includes not only a rigid member but also a flexible member such as a resin film.

In the following description, a slow axis of a film or a layer represents an in-plane slow axis of the film or layer, unless otherwise specified.

In the following description, an angle formed by an optical axis (slow axis, transmission axis, absorption axis, etc.) of each layer in a member including a plurality of layers represents an angle when the layer is viewed from the thickness direction, unless otherwise specified.

In the following description, a front direction of a certain film means the normal direction of the principal surface of the film, specifically, a direction at the polar angle 0° and the azimuth angle 0° of the principal surface, unless otherwise specified.

In the following description, an oblique direction of a certain film means a direction which is neither parallel nor perpendicular to the principal surface of the film, specifically, a direction in a polar angle range of greater than 0° and lesser than 90° of the principal surface, unless otherwise specified.

In the following description, an in-plane retardation Re of a layer is a value represented by “Re=(nx−ny)×d” unless otherwise specified. A thickness-direction retardation Rth of a layer is a value represented by “Rth=[{(nx+ny)/2}−nz]×d” unless otherwise specified. An NZ factor of a layer is a value represented by “(nx−nz)/(nx−ny) unless otherwise specified. Herein, nx represents a refractive index in a direction in which the maximum refractive index is given among directions perpendicular to the thickness direction of the layer (in-plane directions), ny represents a refractive index in a direction, among the above-mentioned in-plane directions of the layer, perpendicular to the direction giving nx, nz represents a refractive index in the thickness direction of the layer, and d represents the thickness of the layer. The measurement wavelength is 590 nm, unless otherwise specified.

In the following description, a direction of an element being “parallel”, “perpendicular” or “orthogonal” may allow an error within the range of not impairing the advantageous effects of the present invention, for example, within a range of ±3°, ±2°, or ±1°, unless otherwise specified.

The positivity or negativity of the intrinsic birefringence value of a polymer is defined by the behavior of the refractive index of a molded product of the polymer when the molded product has been stretched. That is, a polymer having a positive intrinsic birefringence value is a polymer in which the refractive index of the molded product thereof in the stretched direction is greater than before stretching. Also, a polymer having a negative intrinsic birefringence value is a polymer in which the refractive index of the molded product thereof in the stretched direction is smaller than before stretching. An intrinsic birefringence value may be calculated from a dielectric constant distribution.

That a certain specific polymerization unit has a positive intrinsic birefringence value means that a polymer formed only of the polymerization unit has a positive intrinsic birefringence value. That a certain specific polymerization unit has a negative intrinsic birefringence value means that a polymer formed only of the polymerization unit has a negative intrinsic birefringence value. Therefore, the positivity or negativity of the intrinsic birefringence value of a polymerization unit can be easily judged by preparing a homopolymer formed only of the polymerization unit, molding the polymer into a molded product having an optional shape, stretching the molded product, and measuring the optical properties thereof. In general, it is known that many of polymerization units of hydrocarbon such as alkene and diene have a positive intrinsic birefringence value, while many of polymers of hydrocarbon having an aromatic ring on the side chain such as styrene and vinylnaphthalene have a negative intrinsic birefringence value.

In the following description, a block in a polymer composed of a polymerization unit generated by polymerization of a certain monomer may be expressed using the name of the monomer. For example, a block composed of a polymerization unit generated by polymerization of 2-vinylnaphthalene may be referred to as a “2-vinylnaphthalene block”, and a block composed of a polymerization unit generated by polymerization of isoprene may be referred to as an “isoprene block”.

[1. Phase Difference Film]

The phase difference film of the present embodiment is formed of a resin C.

[1.1. Resin C]

The resin C includes a specific copolymer P. The copolymer P contains a polymerization unit A and a polymerization unit B. The copolymer P is preferably a block copolymer having a block (A) containing as a main component the polymerization unit A, and a block (B) containing as a main component the polymerization unit B. In general, a block copolymer is a polymer having a molecular structure in which a plurality of types of blocks are linked, and each block is a chain constituted by connection of polymerization units. A specific block copolymer in an embodiment of the present invention has specific blocks (A) and (B). In the following description, such specific block copolymers may simply be referred to as “block copolymers”. Herein, the polymerization unit which is a main component in a certain block refers to a polymerization unit which is 50% by weight or more relative to the total weight of the polymerization units constituting the block.

The polymerization unit A may have a negative intrinsic birefringence value. On the other hand, the polymerization unit B may be a unit having a positive intrinsic birefringence value.

Examples of the polymerization unit A may be a unit having a unit represented by the following general formula (A).

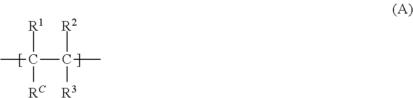

R^{C} is a group selected from the group consisting of a phenyl group, a biphenylyl group (e.g., a 4-biphenylyl group, a 2-biphenylyl group, and a 3-biphenylyl group), a naphthyl group (e.g., a 1-naphthyl group, and a 2-naphthyl group), an anthracenyl group (e.g., an anthracene-1-yl group, an anthracene-2-yl group, and an anthracene-9-yl group), a phenanthrenyl group (e.g., a phenanthrene-1-yl group, a phenanthrene-2-yl group, a phenanthrene-3-yl group, a phenanthrene-4-yl group, and a phenanthrene-9-yl group), a naphthacenyl group (e.g., a naphthacen-1-yl group, a naphthacen-2-yl group, and a naphthacen-5-yl group), a pentacenyl group (e.g., a pentacen-1-yl group, a pentacen-2-yl group, a pentacen-5-yl group, and a pentacen-6-yl group), and a terphenylyl group.

R¹ to R³ are each independently one selected from the group consisting of a hydrogen atom and an alkyl group of 1 to 12 carbon atoms. Examples of such alkyl groups may include a methyl group, an ethyl group, a propyl group, and a hexyl group.

In the formula (A),

R¹ is preferably a hydrogen atom or a methyl group, more preferably a hydrogen atom.

R² and R³ are preferably a hydrogen atom.

R^{C} is preferably a naphthyl group or a phenyl group, more preferably a naphthyl group.

It is more preferable that R² and R³ are a hydrogen atom and R^{C} is a naphthyl group or a phenyl group, or R² and R³ are a hydrogen atom and R¹ is a hydrogen atom. It is still more preferable that R² and R³ are a hydrogen atom, R^{C} is a naphthyl group, and R¹ is a hydrogen atom (a vinylnaphthalene unit). Alternatively, it is still more preferable that R¹, R² and R³ are a hydrogen atom, and R^{C} is a phenyl group (styrene unit). It is most preferable that R² and R³ are a hydrogen atom, R^{C} is a naphthyl group, and R¹ is a hydrogen atom.

The polymerization unit A may be obtained by polymerizing a monomer (a) that gives the polymerization unit A. Examples of the monomer (a) may include vinylnaphthalene and derivatives thereof, and styrene and derivatives thereof. As the monomer (a) that gives the polymerization unit A, vinylnaphthalene, a vinylnaphthalene derivative, styrene, and a styrene derivative are preferable. Thus, in an embodiment, the polymerization unit A is preferably a vinylnaphthalene unit, a vinylnaphthalene derivative unit, a styrene unit, or a styrene derivative unit.

Examples of the vinylnaphthalene may include 1-vinylnaphthalene and 2-vinylnaphthalene. Examples of the vinylnaphthalene derivative may include α-alkylvinylnaphthalene (e.g., α-methyl-1-vinylnaphthalene, α-ethyl-1-vinylnaphthalene, α-propyl-1-vinylnaphthalene, α-hexyl-1-vinylnaphthalene, α-methyl-2-vinylnaphthalene, α-ethyl-2-vinylnaphthalene, α-propyl-2-vinylnaphthalene, and α-hexyl-2-vinylnaphthalene). As the vinylnaphthalene and its derivatives, 2-vinylnaphthalene is preferable from the viewpoint of convenient industrial availability.

Examples of the styrene derivatives may include α-alkylstyrene (e.g., α-methylstyrene and α-ethylstyrene). As styrene and its derivatives, styrene is preferable from the viewpoint of convenient industrial availability.

As the polymerization unit A, the copolymer P may have one type thereof solely, and may also have two or more types thereof in combination at any ratio. Therefore, as the monomer (a) for forming the polymerization unit A, one type thereof may be solely used, and two or more types thereof may also be used in combination at any ratio.

The copolymer P may contain a polymerization unit that is a hydrogenation product of the polymerization unit A. The polymerization unit that is a hydrogenation product of the polymerization unit A is a polymerization unit that has a structure of a hydrogenation product of the polymerization unit A. Hereinafter, a polymerization unit that is a hydrogenation product of the polymerization unit A is also referred to as a polymerization unit HA. The polymerization unit HA may be a unit produced by any method.

Examples of the polymerization unit HA may include a unit obtained by adding a hydrogen atom to part or all of unsaturated bonds included in the group represented by R^{C} in the unit represented by the general formula (A).

The molar ratio (HA/A) of the polymerization unit HA relative to the polymerization unit A in the copolymer P is preferably 10/90 or less, more preferably 5/95 or less, still more preferably 2/98 or less, and most preferably 1/99 or less, and may be 0/100 or more, but is ideally 0/100. The molar ratio (HA/A) in the copolymer P may be determined by measuring ¹H-NMR of the copolymer P.

When a plurality of types of the polymerization units HA are contained in the copolymer P, the molar ratio (HA/A) means the sum of the respective molar ratios of the plurality of types of the polymerization units HA. When a plurality of types of the polymerization units A are contained in the copolymer P, the molar ratio (HA/A) means the molar ratio of the polymerization unit HA relative to the total molar number of the plurality of types of the polymerization units A.

Examples of the polymerization unit B may include a unit represented by the following general formula (B-1) and a unit represented by the following general formula (B-2).

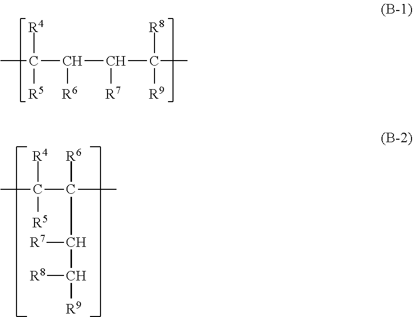

R⁴ to R⁹ are each independently a hydrogen atom or one selected from the group consisting of an alkyl group of 1 to 6 carbon atoms. Examples of such alkyl groups may include a methyl group, an ethyl group, a propyl group, and a hexyl group. Preferably, R⁴ to R⁹ are each independently a hydrogen atom or a methyl group.

The polymerization unit B may be obtained by polymerizing a monomer (b) which is capable of giving a polymerization unit B to form a polymerization unit, and further hydrogenating double bonds if such double bonds are present in the polymerization unit. Examples of the monomer (b) may include compounds represented by the following general formula (bm).

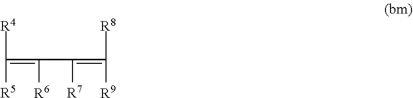

In the above-described general formula (bm), the definitions for R⁴ to R⁹ are the same as those in the general formula (B-1) and the general formula (B-2).

Preferable examples of the monomers (b) may include butadiene (R⁴ to R⁹ in the formula (bm) are all hydrogen atoms), isoprene (R⁶ or R⁷ of R⁴ to R⁹ in the formula (bm) is a methyl group and the others are hydrogen atoms), 1,3-pentadiene, 2,3-dimethyl-1,3-butadiene, 1,3-hexadiene, 2-methyl-1,3-pentadiene, 3-methyl-1,3-pentadiene, and 2,4-dimethyl-1,3-pentadiene. Of these, butadiene and isoprene are more preferable from the viewpoint of obtaining a resin C excellent in transparency, heat resistance, and processability. Preferable examples of the polymerization unit B may include those having the same R⁴ to R⁹ as those in the preferable examples of the monomer (b). More preferable examples of the polymerization unit B may include a unit that is a hydrogenation product of an isoprene unit, a unit that is a hydrogenation product of a butadiene unit, a unit that is a hydrogenation product of a 1,3-pentadiene unit, a unit that is a hydrogenation product of a 2,3-dimethyl-1,3-butadiene unit, a unit that is a hydrogenation product of a 1,3-hexadiene unit, a unit that is a hydrogenation product of a 2-methyl-1,3-pentadiene unit, a unit that is a hydrogenation product of a 3-methyl-1,3-pentadiene unit, and a unit that is a hydrogenation product of a 2,4-dimethyl-1,3-pentadiene unit.

Herein, a unit that is a hydrogenation product of a certain unit is a unit that has a structure obtained by hydrogenating the certain unit. A unit that is a hydrogenation product of a certain unit may be a unit produced by an optional method.

As the polymerization unit B, the copolymer P may have one type thereof solely, and may also have two or more types thereof in combination at any ratio. Therefore, as the monomer (b) for forming the polymerization unit B, one type thereof may be solely used, and two or more types thereof may also be used in combination at any ratio.

The copolymer P may contain a polymerization unit hydrogenation of which gives the polymerization unit B.

The polymerization unit hydrogenation of which gives the polymerization unit B is a polymerization unit that has a structure of dehydrogenation product the polymerization unit B. Hereinafter, a polymerization unit hydrogenation of which gives the polymerization unit B is also referred to as a polymerization unit B′. The polymerization unit B′ may be a unit produced by any method.

Examples of the polymerization unit B′ may include a unit represented by the following general formula (B′-1) and a unit represented by the following general formula (B′-2).

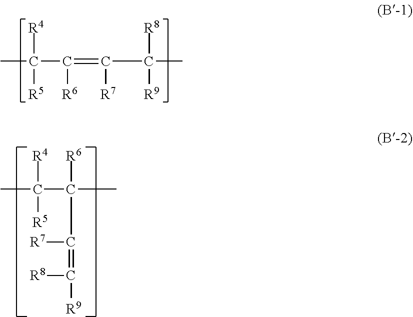

In the general formula (B′-1) and the general formula (B′-2), the definitions for the R⁴ to R⁹ are the same as those in the general formula (B-1) and the general formula (B-2).

The molar ratio (B′/B) of the polymerization unit B′ relative to the polymerization unit B in the copolymer P is preferably 10/90 or less, more preferably 5/95 or less, still more preferably 2/98 or less, and most preferably 1/99 or less, and may be 0/100 or more, but is ideally 0/100. In the copolymer P, the molar ratio (B′/B) may be determined by measuring the NMR of the copolymer P.

When a plurality of types of the polymerization units B′ are contained in the copolymer P, the molar ratio (B′/B) means the sum of the respective molar ratios of the plurality of types of polymerization units B′. When a plurality of types of polymerization units B are contained in the copolymer P, the molar ratio (B′/B) means the molar ratio of the polymerization unit B′ relative to the total molar number of the plurality of types of the polymerization units B.

Therefore, when the polymerization unit B is a unit represented by the general formula (B-1) or a unit represented by the general formula (B-2), and the polymerization unit B′ is a unit represented by the general formula (B′-1) or a unit represented by the general formula (B′-2), the molar ratio (B′/B) in the copolymer P is a total molar ratio of a unit represented by the general formula (B′-1) and a unit represented by the general formula (B′-2) relative to a total molar number of a unit represented by the general formula (B-1) and a unit represented by the general formula (B-2), that is, a sum of the molar ratio of the unit represented by the general formula (B′-1) and the molar ratio of the unit represented by the following general formula (B′-2).

When the copolymer P has the block (A), the block (A) may have an optional polymerization unit other than the polymerization unit A. Examples of such optional polymerization units may include a unit formed by polymerization of an optional monomer copolymerizable with the monomer (a), and a unit formed by hydrogenation of the unit.

When the copolymer P has a block (B), the block (B) may have an optional polymerization unit other than the polymerization unit B. Examples of such optional polymerization units may include a polymerization unit obtained by polymerizing a monomer (b) and having a double bond remained without being hydrogenated, and a unit formed by polymerization of an optional monomer copolymerizable with the monomer (b) and a unit formed by hydrogenation of the unit.

However, from the viewpoint of expression of optical properties and mechanical properties of the resin C, it is preferable that both of the ratio of the polymerization unit A in the block (A) and the ratio of the polymerization unit B in the block (B) are high. The ratio of the polymerization unit A in the block (A) is preferably 50% by weight or more, more preferably 75% by weight or more, and still more preferably 95% by weight or more, and particularly preferably, the block (A) is formed only of the polymerization unit A. The ratio of the polymerization unit B in the block (B) is preferably 50% by weight or more, more preferably 75% by weight or more, and still more preferably 95% by weight or more, and particularly preferably, the block (B) is formed only of the polymerization unit B.

The block (A) and the block (B) are preferably incompatible. When these blocks are incompatible, a phase separation structure can be easily obtained in a phase difference film. Whether the block (A) and the block (B) are incompatible or not may be judged based on presence or absence of the compatibility between a homopolymer formed of the polymerization unit A and a homopolymer formed of the polymerization unit B, which have molecular weights that are at the same levels as the sizes of these blocks in the block copolymer. Presence or absence of the compatibility between such homopolymers may be judged by mixing these homopolymers to obtain a mixture and judging whether these are phase-separated when placed at a temperature at which these are in a melting state.

The molecular structure of the copolymer P is not particularly limited as long as it has the polymerization unit A and the polymerization unit B, and may be a molecular structure having any optional configuration. For example, when the copolymer P is a block copolymer, the block copolymer may be a linear block copolymer or a graft block copolymer.

Examples of linear block copolymers may include a diblock copolymer having a block configuration (A)-(B) in which blocks (A) and (B) are connected to each other; a triblock copolymer having a block configuration (A)-(B)-(A) in which a block (A), a block (B), and another block (A) are connected to each other in this order (herein, sometimes referred to as “triblock copolymer P′”); a pentablock copolymer having a block configuration in which three blocks (A) and two blocks (B) are connected in the order of (A)-(B)-(A)-(B)-(A); and a linear block copolymer having a block configuration in which a greater number of blocks are connected. Examples of the block configurations in which a large number of blocks are connected may include (A)-((B)-(A))n-(B)-(A), and (B)-((A)-(B))n-(A)-(B) (n is an integer greater than or equal to 1).

Examples of the graft block copolymer may include a block copolymer having a block configuration of (A)-g-(B) in which the block (B) is connected to the block (A) as a side chain.

From the viewpoint of causing the resin C to express desired optical properties, the copolymer P may preferably be a block copolymer having a molecular structure having two or more polymer blocks (A) and one or more polymer blocks (B) per molecule. More preferably, the block copolymer may be a triblock copolymer with the block configuration of (A)-(B)-(A).

The weight fraction of the polymerization unit A in the copolymer P may be adjusted to a value with which desired optical properties are expressed. The weight fraction of the polymerization unit A refers to the weight of the polymerization unit A relative to the total weight of the polymerization units constituting the copolymer P. When the resin C includes a plurality of types of copolymer P, the weight fraction of the polymerization unit A referred to herein is the weight of the polymerization unit A relative to the total weight of the polymerization units in the entire plurality of types of copolymer P contained.

The weight fraction of the polymerization unit A in the copolymer P is preferably 50% by weight or more, more preferably 55% by weight or more, and still more preferably 60% by weight or more, and is preferably 90% by weight or less, more preferably 85% by weight or less, still more preferably 75% by weight or less, and particularly preferably less than 70% by weight, and is preferably 55% by weight or more and less than 75% by weight, more preferably 55% by weight or more and less than 70% by weight.

The molecular weight of the copolymer P is not particularly limited, and may be appropriately adjusted to a range in which preferable optical properties and mechanical properties can be obtained. The molecular weight of the copolymer P may be, for example, in the range of 50,000 to 400,000. In addition, the glass transition temperature Tg of the copolymer P may be, for example, in the range of 110° C. to 150° C. The glass transition temperature Tg of the copolymer P may be determined by thermomechanical analysis (TMA).

It is preferable that the copolymer P has a negative intrinsic birefringence value. Such negative intrinsic birefringence values may be imparted by adjusting the ratio of the polymerization units in the copolymer P. Specifically, by adopting a unit having a negative intrinsic birefringence value as the polymerization unit A, and adjusting the weight fraction of the polymerization unit A within a range of the above-described lower limit or more, it is possible to obtain the copolymer P having a negative intrinsic birefringence value. The copolymer P having a negative intrinsic birefringence value can impart desired optical properties to the phase difference film.

The resin C may be formed only of the copolymer P, and may include an optional component in addition to the copolymer P. Examples of the optional components may include additives such as a dye, a pigment, and an antioxidant. The ratio of such optional components may be within the range that does not impair the advantageous effects of the present invention. Specifically, the ratio of the copolymer P in the resin C is preferably 98% by weight or more, and more preferably 99% by weight or more, and is usually 100% by weight or less. More preferably, the resin C is formed only of the copolymer P.

[1.2. Properties, Shapes and Others of Optical Film]

The optical film of the present embodiment contains a phase separation structure that expresses structural birefringence. The phase separation structure is formed in the layer of the resin C constituting the optical film. The phase separation structure of the resin C means that a portion composed of the polymerization unit A (for example, the block (A)) and a portion composed of the polymerization unit B (for example, the block (B)) of the copolymer P in the resin C are self-assembled, and a phase containing as a main component the polymerization unit A (also referred to as a phase (A)) and a phase containing as a main component the polymerization unit B (also referred to as a phase (B)) are thereby separated into distinguishable separate phases in the layer. In the following description, these phases are sometimes merely referred to as a “phase of the polymerization unit A” and a “phase of the polymerization unit B”. An orientation layer exhibiting such a phase separation structure can express structural birefringence when the structure is sufficiently smaller than the wavelength of light.

When the copolymer P is a block copolymer having a block (A) containing as a main component the polymerization unit A and a block (B) containing as a main component the polymerization unit B, the phase (A) is usually composed of the block (A), and the phase (B) is usually composed of the block (B).

Structural birefringence is birefringence caused in structures containing multiple types of phases having different refractive indices, such as the aforementioned phase separation structure. For example, when a certain structure includes, in a phase having a certain refractive index n1, a phase having a refractive index n2 which is different from n1, the structure can express structural birefringence. Structural birefringence is clearly different from orientational birefringence which is caused by the molecular orientation due to stretching, as the structural birefringence occurs even when each phase is formed with an isotropic medium.

Actual occurrence of structural birefringence may be confirmed by measuring optical properties of the film. Since an unstretched film formed by a conventional method such as extrusion molding, pressing, or solvent casting usually has a random molecular orientation, its Re and Rth values are close to 0. On the other hand, in an unstretched film expressing structural birefringence, the observed Re and Rth values are greater than the values observed in an ordinary unstretched film formed by the conventional method. Therefore, expression of structural birefringence can be confirmed by measuring such values. However, expression of structural birefringence can be confirmed more reliably by additionally performing structure observation by an electron microscope or small-angle X-ray scattering.

Specific examples of the phase separation structure may include a lamellar structure, a spheroid structure, and a cylinder structure. Which of these phase separation structures is expressed is influenced by various factors. A main factor that influences the expression of the structure is a volume ratio between a phase containing as a main component the polymerization unit A and a phase containing as a main component the polymerization unit B. The volume ratio between these phases may be adjusted by changing the ratio between the blocks (A) and (B) in the block copolymer. The phase separation structure is preferably a cylinder structure or a lamellar structure.

In the phase separation structure, the size of the structure may be appropriately adjusted within a range in which the optical film can exert desired optical properties. For example, the distance between phases is preferably 200 nm or less, more preferably 150 nm or less, and further preferably 100 nm or less. The size of each of phase-separated phases is preferably 100 nm or less, more preferably 80 nm or less, and further preferably 60 nm or less. The distance between phases indicates, for example, the distance between a lamella and another lamella (that is, the pitch of a repeating unit of a lamellar layer) in a case of a lamella-shape phase separation, the distance between a cylinder and another cylinder in a case of a cylinder-shape phase separation structure, and the distance between a spheroid and another spheroid in a case of a spheroid-shape phase separation structure. The size of the phase-separated phase indicates the thickness of a lamella in a case of lamella-shape phase separation, the cylinder radius in a case of cylinder-shape phase separation, and the spheroid radius in a case of spheroid-shape phase separation structure. As the distance between phases, a value obtained by fitting a scattering pattern obtained through small-angle X-ray scattering measurement to a theoretical curve may be adopted.

When the distance between phases and the size of the phase-separated phase are sufficiently shorter than visible light in this manner, structural birefringence is expressed, and the coloring of the film and the decrease of light transmittance can be suppressed. The lower limit of the distance between phases may be, for example, 10 nm or more, although the lower limit is not restricted thereto. The lower limit of the size of the phase-separated phase may be, for example, 10 nm or more, although the lower limit is not limited thereto. The distance between phases may be adjusted by adjusting the molecular structure of the copolymer P. For example, the adjustment may be effected by adopting a block copolymer as the copolymer P and appropriately adjusting factors such as the lengths of the blocks (A) and (B).

The greater the absolute value |n(A)−n(B)| of the difference between the refractive index n(A) of the polymer (A) formed of the polymerization unit A and the refractive index n(B) of the polymer (B) formed of the polymerization unit B is, the more efficiently structural birefringence can be expressed, and the better the viewing angle properties of the phase difference film produced from the resulting optical film becomes.

|n(A)−n(B)| is preferably 0.12 or more. The greater value is more preferable. The absolute value may be 0.25 or less. The refractive index may be measured by, for example, a prism coupler method.

The greater the absolute value |Tg(A)−Tg(B)| of the difference between the glass transition temperature Tg(A) (° C.) of the polymer (A) and the glass transition temperature (Tg(B) (° C.) of the polymer (B) is, the more viewing angle properties and heat resistance of the phase difference film produced from the resulting optical film are balanced.

|Tg(A)−Tg(B)| is preferably 180° C. or higher. The greater value is more preferable. The absolute value may be 275° C. or less. The glass transition temperature of the polymer (A) and the polymer (B) may be measured, for example, by differential scanning calorimetry. The measuring condition may be a temperature rise rate of 10° C./minute based on JIS K 6911.

The polymer (A) formed of the polymerization unit A may be obtained by polymerizing a monomer corresponding to the polymerization unit A and, if necessary, further performing a reaction such as hydrogenation. The polymer (B) formed of the polymerization unit B may be obtained by polymerizing a monomer corresponding to the polymerization unit B and, if necessary, further performing a reaction such as hydrogenation. When the copolymer P includes the block (A) and the block (B), the polymer (A) and the polymer (B) may be obtained in the same manner as the producing methods for the block (A) and the block (B), respectively.

The content ratio of the polymerization unit A in the phase containing as a main component the polymerization unit A and the content ratio of the polymerization unit B in the phase containing as a main component the polymerization unit B may be adjusted by appropriately adjusting the materials for producing the copolymer P and the producing operation. The content ratio is preferably a high value in terms of expression of the effects. The content ratio of the polymerization unit A in the phase containing as a main component the polymerization unit A is preferably 50% by weight or more, and more preferably 75% by weight or more, and is usually 100% by weight or less, and still more preferably 100% by weight. The content ratio of the polymerization unit B in the phase containing as a main component the polymerization unit B is preferably 50% by weight or more, and more preferably 75% by weight or more, and is usually 100% by weight or less, and still more preferably 100% by weight.

In the optical film, the value of Rth/d, calculated from the thickness-direction retardation Rth (nm) of the film and the film thickness (nm), is usually 2.5×10⁻³ or more, preferably 3.0×10⁻³ or more, and more preferably 3.5×10⁻³ or more, and is preferably 8.0×10⁻³ or less, more preferably 7.0×10⁻³ or less, and still more preferably 6.0×10⁻³ or less. It is preferably 2.5×10⁻³ or more and 8.0×10⁻³ or less, and more preferably 3.0×10⁻³ or more and 8.0×10⁻³ or less. By setting the Rth/d value within the aforementioned range, an optical film capable of producing a phase difference film having excellent viewing angle properties can be obtained.

The thickness of the optical film may be appropriately set depending on the stretching conditions in the subsequent stretching step, the purpose of use, and the like. The thickness is preferably 150 μm or less, and more preferably 100 μm or less, and may be greater than 0 μm and greater than or equal to 15 μm.

The thickness direction retardation Rth of the optical film may be adjusted by regulating the magnitude and direction of the structural birefringence. The magnitude and direction of the structural birefringence may be regulated by adjusting, e.g., shape, layout and volume fraction of each phase exhibiting the phase separation structure, as well as the refractive index difference between the phases. The detail thereof is disclosed in, e.g., Form birefringence of macromolecules (W. L. Bragg et al. 1953). Further, by molding a resin C employing a molding method that tends to enhance the generation the structural birefringence such as a press molding method, the thickness direction retardation Rth of the optical film can be increased.

[2. Method for Producing Optical Film]

The aforementioned optical film may be produced by a production method including a step of forming a single-layer film of a resin C and a step of causing phase-separation of the resin C in such a film.

Examples of a specific film forming method for performing the step of forming a film of a resin C may include a solution casting method, a melt extrusion method, a calendar method, and a compression molding method (press molding method). For efficiently producing a large amount of optical films, a melt extrusion method is particularly preferable. In another embodiment, for stably generating expression of the structural birefringence, press molding method is particularly preferable.

A method for forming a film by a melt extrusion method usually involves extrusion of a resin melted in an extruder through a die and thereafter casting the extruded resin on a cooling roll.

The extrusion speed of the resin from the die may be adjusted by adjusting the screw rotation speed of the extruder. The screw rotation speed of the extruder is preferably 10 rpm or more and more preferably 20 rpm or more, and preferably 80 rpm or less and more preferably 60 rpm or less. When the screw rotation speed of the extruder falls within the aforementioned range, the phase separation structure of the resin C can be easily formed.

The temperature of the cooling roll is preferably 120° C. or higher and more preferably 130° C. or higher, and preferably 150° C. or lower and further preferably 145° C. or lower.

In any method, the step of forming the film of the resin C is usually performed while heating the resin C. In the step of forming the film of the resin C, the heating temperature of the resin C is usually 150° C. or higher, preferably 180° C. or higher, and more preferably 200° C. or higher, and is preferably 320° C. or lower, more preferably 300° C. or lower, and further preferably 290° C. or lower.

The step of causing phase-separation of the resin C in the film may be performed either after or simultaneously with the step of forming the film.

The step of phase-separation may be performed by, for example, slowly cooling the melted resin C. Specifically, when a melt extrusion method and other methods are adopted as the step of forming the film, an operation of molding a resin in a melted state and thereafter cooling the molded resin under slow cooling conditions may be performed. Although the specific action mechanism is not clear, the phase separation structure of the resin C that expresses structural birefringence can be easily formed by such slow cooling, and thereby the optical film having desired optical properties can be easily obtained.

As the step of phase-separation, a step of pressing the film may be performed in addition to or in place of the aforementioned slow cooling. When a pressure is applied to the film of the resin C, the phase separation structure that expresses structural birefringence can be easily formed, and the optical film having desired optical properties can be easily obtained.

Specifically, the step of pressing may be performed by applying a pressure to a sheet piece-shape resin C in its thickness direction. For such an operation, a pressing tool, such as a die, to apply a pressure onto the surface of the film may be used. When the film of the resin C is formed by a press molding method, the step of pressing may be performed either simultaneously with molding as a part of the step of molding, or after molding. The pressure for the pressing is preferably 1 MPa or more, more preferably 5 MPa or more, and still more preferably 10 MPa or more, and is preferably 50 MPa or less, more preferably 45 MPa or less, and still more preferably 40 MPa or less. Pressing time is preferably 10 seconds or more, more preferably 20 seconds or more, and still more preferably 30 seconds or more, and is preferably 1000 seconds or less, more preferably 500 seconds or less, and still more preferably 300 seconds or less. By setting the conditions for the pressing in the aforementioned range, a film having uniform thickness and phase separation structure can be obtained.

The step of pressing may also be performed with a device which continuously applies a pressure on a long-length resin C. For such an operation, a pressing tool such as a pressing roll may be used. When the film of the resin C is molded by a melt extrusion method, the step of pressing may be performed by feeding the resin C extruded from the die between two pressing rolls, to thereby apply a pressure on the resin C. A film having a uniform thickness and phase separation structure can be obtained by appropriately adjusting pressing conditions such as a linear pressure and a temperature of pressing.

[3. Uses of Optical Film]

[3.1. Properties of Phase Difference Film Producible from Optical Film]

The aforementioned optical film as it is may be used for various optical uses. Alternatively, the aforementioned optical film may be stretched to produce a phase difference film with excellent viewing angle properties.

As to the phase difference film that may be produced from the optical film, the value of Re(E)/d(E) calculated from the in-plane retardation Re(E) (nm) and the thickness d(E) (nm) is usually 1.5×10⁻³ or more, preferably 1.8×10⁻³ or more and more preferably 2.0×10⁻³ or more, and is preferably 7.0×10⁻³ or less, more preferably 6.0×10⁻³ or less and still more preferably 5.0×10⁻³ or less. By confining the value of Re(E)/d(E) within the aforementioned range, the viewing angle properties of the phase difference film can be effectively improved.

The NZ factor of the phase difference film that may be produced from the optical film is usually larger than 0, preferably 0.2 or more and more preferably 0.3 or more, and is usually smaller than 1, preferably 0.8 or less and more preferably 0.7 or less. By confining the value of the NZ factor within the aforementioned range, the viewing angle properties of the phase difference film can be effectively improved.

[3.2. Method for Producing Phase Difference Film]

The aforementioned optical film may be stretched to produce a phase difference film with improved viewing angle properties. The step of stretching may be performed on a line continuous to a production line for molding the film of the resin C. Alternatively, the produced film of the resin C may be temporarily wound up to form a film roll. The film may be thereafter unwound from the film roll, and subjected to the step of stretching. The step of stretching is usually performed by a flat method stretching in which the film is stretched in its in-plane direction. Examples of the flat method stretching may include a uniaxial stretching method and a biaxial stretching method. The uniaxial stretching method involves stretching of a film in one of its in-plane directions. Examples thereof may include a free width uniaxial stretching method and a constant width uniaxial stretching method. The biaxial stretching method involves the stretching a film in two of its in-plane directions. Examples of the biaxial stretching method may include a sequential biaxial stretching method and a simultaneous biaxial stretching method. The stretching in each direction may be either free width stretching or constant width stretching. More specific examples of the sequential biaxial stretching method may include an all tenter system and a roll tenter system. The stretching method for the step of stretching in the production method of the present embodiment may be any of these methods, and an appropriate method for achieving a desired phase difference film may be selected.

### EXAMPLE

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The operation described below was performed under the conditions of normal temperature and normal pressure, unless otherwise specified.

[Evaluation Method]

(Retardation, NZ Factor, Rth/d, and Re/d of Film)

Using AxoScan manufactured by Axometrics Inc., the thickness-direction retardation Rth, in-plane retardation Re, and NZ factor of the film was obtained at a wavelength of 590 nm.

From the obtained Rth (nm) and the thickness d (nm) of the film, Rth/d was obtained. From the obtained Re (nm) and the thickness d (nm) of the film, Re/d was obtained.

NZ factor was obtained from the Rth and Re with the following formula.

NZ factor=Rth/Re+0.5

(Phase Separation Structure)

The film was cut into a size of 2 mm×4 mm to obtain a plurality of film pieces. 30 pieces thereof were stacked in the thickness direction and fixed to a folder. Then, small-angle X-ray scattering measurement was performed in a small-angle X-ray scattering measurement facility (Aichi SR, beamline 8S3) to obtain a scattering pattern. The measurement conditions were camera length: 4 m, X-ray energy: 8.2 KeV, measurement q range: about 0.06 to 3 nm⁻¹, and exposure time to light per sample: 60 seconds. Fitting of the obtained scattering pattern to the theoretical curve was performed, and therefrom the phase separation structure and the distance between phases were calculated.

The surface irradiated with X-ray was the cross section of the film, and the integration range was 20° in each of the thickness direction and a direction perpendicular to the thickness direction. The distance between phases was calculated from data obtained from each integration, and an average value of the distances between phases in the thickness direction and the direction perpendicular to the thickness direction was adopted as a measurement value.

(Refractive Index)

The refractive index at a wavelength of 532 nm of the sample was obtained by measuring refractive indices at three wavelengths of 407 nm, 532 nm, and 633 nm using a refractive index film thickness measuring device (“Prism Coupler” manufactured by Metricon Corporation) and performing Cauchy fitting of the measured values.

(Measurement of Glass Transition Temperature by Thermomechanical Analysis (TMA))

From the film to be measured, a 5 mm×20 mm rectangular sample was cut out. The sample was mounted to a thermomechanical analyzer (“TMA/SS7100” manufactured by SII Nano Technology Inc.). The temperature was changed while a tension of 50 mN was applied to the sample in the lengthwise direction thereof, and the temperature at the inflection point of linear expansion was adopted as Tg (° C.).

(Measurement of Glass Transition Temperature by Differential Scanning Calorimetric Analysis (DSC))

The glass transition temperature (Tg) of the sample was measured using a differential scanning calorimeter (manufactured by SII Nano Technology Inc., product name: DSC6220), in accordance with JIS K 6911, under the condition of a temperature increasing rate of 10° C./min.

(Positivity or Negativity of Intrinsic Birefringence Value of Copolymer)

A film was produced from the copolymer. The positivity or negativity of the intrinsic birefringence value of the copolymer was determined by the behavior of the refractive index upon stretching the film. When the refractive index of the film after stretching in the stretched direction was greater than that before stretching, the intrinsic birefringence of the copolymer was determined as positive. When the refractive index of the film after stretching in the stretched direction was smaller than that before stretching, the intrinsic birefringence of the copolymer was determined as negative.

(Evaluation of Viewing Angle Properties) (Display Properties (λ/4 Plate))

As a polarizing plate, a long-length polarizing plate having a transmission axis in its width direction (manufactured by Sanritz Corporation, trade name “HLC2-5618S”, thickness 180 μm) was prepared. The protective film on one surface of the polarizing plate was removed, and the phase difference film as the λ/4 plate to be evaluated was bonded to the surface. The bonding was performed such that the slow axis direction of the phase difference film and the transmission axis direction of the polarizing plate form an angle of 45°. By this operation, a polarizing plate including the phase difference film to be evaluated as one of the protective films on both surfaces was obtained. A polarizing plate originally disposed on the viewing side of a commercially available organic electroluminescence (EL) display device (manufactured by LG Electronics Inc., OLED55EG9600) was replaced with the obtained polarizing plate. Accordingly, an organic EL display device including the phase difference film to be evaluated was obtained. In replacing, the polarizing plate was disposed such that the side thereof having a phase difference film to be evaluated was on the organic EL element side. The transmission axis of the polarizer was set in the same direction as that of a polarizer in the polarizing plate that had originally been disposed in the organic EL display device.

The display state of the obtained organic EL display device was observed from an oblique direction with respect to the display surface (45° to the normal direction) at various azimuth angles, and the display state was evaluated according to the following criteria.

Excellent: Comparing with the result before replacement, the values of reflectivity were reduced as to three of the phase difference film of stretching ratio 2 times, the phase difference film of stretching ratio 3 times, and the phase difference film of stretching ratio 4 times.

Good: Comparing with the result before replacement, the values of reflectivity were reduced as to two of the phase difference film of stretching ratio 2 times, the phase difference film of stretching ratio 3 times, and the phase difference film of stretching ratio 4 times.

Poor: Comparing with the result before replacement, the value of reflectivity was reduced as to one of the phase difference film of stretching ratio 2 times, the phase difference film of stretching ratio 3 times, and the phase difference film of stretching ratio 4 times, or the values of reflectivity were reduced as to none of them.

### Example 1

(1-1. Triblock Copolymer)

(First Stage)

Into a pressure resistant reaction vessel dried and purged with a nitrogen gas, 500 parts of toluene as a solvent and 0.03 part of n-butyl lithium as a polymerization catalyst were charged. After that, 12.1 parts of 2-vinylnaphthalene was added as the monomer (a). The mixture was reacted at 25° C. for 1 hour for performing the polymerization reaction of the first stage.

(Second Stage)

After the polymerization reaction of the first stage completed, 11.9 parts of butadiene was added as the monomer (b). The mixture was further reacted at 25° C. for 1 hour for performing the polymerization reaction of the second stage. As a result, a diblock copolymer having a block configuration of (2-vinylnaphthalene block)-(butadiene block) was obtained in the reaction mixture.

(Third Stage)

After that, 12.1 parts of 2-vinylnaphthalene as the monomer (a) was further added to the reaction mixture. The mixture was reacted at 25° C. for 1 hour for performing the polymerization reaction of the third stage. As a result, a triblock copolymer having a block configuration of (2-vinylnaphthalene block)-(butadiene block)-(2-vinylnaphthalene block) was obtained in the reaction mixture. The reaction mixture was poured into a large amount of 2-propanol to thereby cause precipitation of the triblock copolymer, which was then isolated.

The obtained triblock copolymer was dissolved in 700 parts of p-xylene to obtain a solution. To the solution, 7.6 parts of p-toluene sulfonyl hydrazide was added and reacted at a temperature of 130° C. for 8 hours. Through this reaction, hydrogen was added to a double bond of a butadiene unit. After completion of the hydrogenation, the reaction solution was poured into a large amount of 2-propanol to obtain a triblock copolymer P1 having a block configuration of (block (A))-(block (B))-(block (A)) as a lump-shape product. In the triblock copolymer P1, the block (A) was a 2-vinylnaphthalene block, and the block (B) was a hydrogenated butadiene block.

The obtained triblock copolymer P1 was analyzed by ¹H-NMR. As a result, the weight ratio of the 2-vinylnaphthalene unit as the polymerization unit A relative to the hydrogenated butadiene unit as the polymerization unit B in the triblock copolymer was 67:33. Thus, the weight fraction of the polymerization unit A was 67%. The hydrogenation rate of the 2-vinylnaphthalene unit was 0%, and the hydrogenation rate of the butadiene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (butadiene unit) relative to the polymerization unit B (hydrogenated butadiene unit) was 1/99. The weight-average molecular weight of the triblock copolymer P1 measured by gel permeation chromatography (GPC) was 110000. The glass transition temperature of the triblock copolymer P1 measured by TMA was 137° C. The intrinsic birefringence value of the triblock copolymer P1 is negative.

(1-2. Pre-Stretch Film)

The triblock copolymer P1 obtained in the aforementioned (1-1) was used as the resin C. The resin C was pulverized by a pulverizer to obtain a powder. The obtained powder was placed between a pair of polyimide films (each having a thickness of 100 μm) to obtain a layered body, and a pressure was applied to the layered body. The pressure application was performed using a press apparatus with electric heater. The conditions for pressing was temperature of 270° C., pressure of 40 MPa, and pressing time of 5 minutes. After the completion of the pressing, the pressure was released and cooling to the room temperature was effected in the air. Then the polyimide films were removed. By this operation, a plurality of pieces of pre-stretch films 1 as optical films each having a thickness of 80 to 120 μm were produced.

For the obtained pre-stretch film 1, the phase structure was observed by irradiation of the cross section with X-ray by the small-angle X-ray scattering method under the aforementioned conditions. As a result, a cylinder structure was observed. The distance between phases was 40 nm. Furthermore, a cut piece of a cross section parallel to the thickness direction was prepared and observed by TEM. As a result, a cylinder-shape phase separation structure was confirmed.

The Rth/d of the obtained pre-stretch film 1 was measured. The result was Rth/d=6.0×10⁻³.

(1-3. Phase Difference Film (λ/4 Plate))

The pre-stretch film 1 obtained in the aforementioned (1-2) was cut to obtain an 80 mm×80 mm rectangular film.

The rectangular film was subjected to free width uniaxial stretching. The stretching was performed using a batch-type stretching device manufactured by Toyo Seiki Seisaku-sho, Ltd. The stretching conditions were stretching temperature of 147° C., stretching speed of 33%/min, and stretching ratio of 2.0 times, 3.0 times and 4.0 times (three levels). As a result of using the pre-stretch films 1 having different thickness, three types of phase difference films 1Q acting as λ/4 plates with a thickness of 50 to 65 μm were obtained. Using the obtained three types of the phase difference films 1Q that function as λ/4 plates, the viewing angle properties were evaluated by the aforementioned method. Further, values of Re/d and NZ factors of the phase difference films 1Q were measured.

### Example 2

(2-1. Triblock Copolymer)

A triblock copolymer P2 was obtained as a lump-shape product by the same manner as that of Example 1 (1-1. Triblock copolymer) except for the following matter.
As the monomer (b), isoprene was used instead of butadiene.

The triblock copolymer P2 has a block configuration of (block (A))-(block (B))-(block (A)). In the triblock copolymer P2, the block (A) was a 2-vinylnaphthalene block and the block (B) was a hydrogenated isoprene block.

The obtained triblock copolymer P2 was analyzed by ¹H-NMR. As a result, the weight ratio of the 2-vinylnaphthalene unit as the polymerization unit A relative to the hydrogenated isoprene unit as the polymerization unit B in the triblock copolymer was 67:33, and thus, the weight fraction of the polymerization unit A was 67%. The hydrogenation rate of the 2-vinylnaphthalene unit was 0%, and the hydrogenation rate of the isoprene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (isoprene unit) relative to the polymerization unit B (hydrogenated isoprene unit) was 1/99. The weight-average molecular weight of the triblock copolymer P2 measured by GPC was 100000. The glass transition temperature of the triblock copolymer P2 measured by TMA was 138° C. The intrinsic birefringence value of the triblock copolymer P2 is negative.

(2-2. Pre-Stretch Film)

The triblock copolymer P2 obtained in (2-1) was used as the resin C. The resin C was pulverized by a pulverizer to obtain a powder. The obtained powder was supplied into an extruder and melted at a resin temperature of 270° C. in the extruder. The melted powder was passed through a polymer pipe and a polymer filter and extruded from a T die onto a casting drum into a sheet shape. The extruded product was cooled to obtain a pre-stretch film 1 with a thickness of 90 μm. The cooling roll temperature was set to 138° C. The screw rotation speed of the extruder was set to 20 to 40 rpm. The produced pre-stretch film 1 was wound up into a roll shape for collection.

For the obtained pre-stretch film 2, the phase structure was observed by irradiation of the cross section with X-ray by the small-angle X-ray scattering method under the aforementioned conditions. As a result, a cylinder structure was observed. Furthermore, a cut piece of a cross section parallel to the thickness direction was prepared and observed by TEM. As a result, a cylinder-shape phase separation structure was confirmed. The distance between phases was 40 nm.

The Rth/d of the obtained pre-stretch film 2 was measured. The result was Rth/d=4.6×10⁻³.

(2-3. Phase Difference Film (λ/4 Plate))

Three types of phase difference films 2Q with a thickness of 50 to 70 μm were obtained by the same manner as that of Example 1 (1-3. Phase difference film (λ/4 plate)) except for the following matters.
The pre-stretch film 2 was used instead of the pre-stretch film 1.
The stretching temperature was changed to 148° C.

Using the obtained three types of the phase difference films 2Q, the viewing angle properties were evaluated by the aforementioned methods. Further, values of Re/d and NZ factors of the phase difference films 2Q were measured.

### Example 3

(3-1. Triblock Copolymer)

The triblock copolymer P2 produced in Example 2 (2-1. Triblock copolymer) was prepared.

(3-2. Pre-Stretch Film)

A pre-stretch film 3 was produced by the same manner as that of Example 1 (1-2. Pre-stretch film) except for the following matter.
The triblock copolymer P2 was used as the resin C instead of the triblock copolymer P1.

For the obtained pre-stretch film 3, the phase structure was observed by irradiation of the cross section with X-ray by the small-angle X-ray scattering method under the aforementioned conditions. As a result, a cylinder structure was observed. The distance between phases was 45 nm. Furthermore, a cut piece of a cross section parallel to the thickness direction was prepared and observed by TEM. As a result, a cylinder-shape phase separation structure was confirmed.

The Rth/d of the obtained pre-stretch film 3 was measured. The result was Rth/d=3.7×10⁻³.

(3-3. Phase Difference Film (λ/4 Plate))

Three types of phase difference films 3Q with a thickness of 50 to 65 μm were obtained by the same manner as that of Example 1 (1-3. Phase difference film (λ/4 plate)) except for the following matters.
The pre-stretch film 3 was used instead of the pre-stretch film 1.
The stretching temperature was changed to 148° C. Using the three types of the obtained phase difference films 3Q, the viewing angle properties were evaluated by the aforementioned methods. Further, values of Re/d and NZ factors of the phase difference films 3Q were measured.

### Example 4

(4-1. Triblock Copolymer)

A triblock copolymer P4 was obtained as a lump-shape product by the same manner as that of Example 1 (1-1. Triblock copolymer) except for the following matters.
In the reaction of (first stage), 13.5 parts of 2-vinylnaphthalene was added as the monomer (a).
In the reaction of (second stage), 9.0 parts of isoprene was added instead of 11.9 parts of butadiene as the monomer (b).
In the reaction of (third stage), 13.5 parts of 2-vinylnaphthalene was added as the monomer (a).

The triblock copolymer P4 has a block configuration of (block (A))-(block (B))-(block (A)). In the triblock copolymer P4, the block (A) was a 2-vinylnaphthalene block and the block (B) was a hydrogenated isoprene block.

The obtained triblock copolymer P4 was analyzed by ¹H-NMR. As a result, the weight ratio of the 2-vinylnaphthalene unit as the polymerization unit A relative to the hydrogenated isoprene unit as the polymerization unit B in the triblock copolymer was 75:25. Thus, the weight fraction of the polymerization unit A was 75%. The hydrogenation rate of the 2-vinylnaphthalene unit was 0%, and the hydrogenation rate of the isoprene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (isoprene unit) relative to the polymerization unit B (hydrogenated isoprene unit) was 1/99. The weight-average molecular weight of the triblock copolymer P4 measured by GPC was 120000. The glass transition temperature of the triblock copolymer P4 measured by TMA was 142° C. The intrinsic birefringence value of the triblock copolymer P4 is negative.

(4-2. Pre-Stretch Film)

A pre-stretch film 4 was produced by the same manner as that of Example 1 (1-2. Pre-stretch film) except for the following matters.
The triblock copolymer P4 was used as the resin C instead of the triblock copolymer P1.

For the obtained pre-stretch film 4, the phase structure was observed by irradiation of the cross section with X-ray by the small-angle X-ray scattering method under the aforementioned conditions. As a result, a cylinder structure was observed. The distance between phases was 50 nm. Furthermore, a cut piece of a cross section parallel to the thickness direction was prepared and observed by TEM. As a result, a lamella-shape phase separation structure was confirmed.

The Rth/d of the obtained pre-stretch film 4 was measured. The result was Rth/d=3.2×10⁻³.

(4-3. Phase Difference Film (λ/4 Plate))

Three types of phase difference films 4Q with a thickness of 60 to 80 μm was obtained by the same manner as that of Example 1 (1-3. Phase difference film (λ/4 plate)) except for the following matters.
The pre-stretch film 4 was used instead of the pre-stretch film 1.
The stretching temperature was changed to 152° C.

Using the obtained three types of the phase difference films 4Q, the viewing angle properties were evaluated by the aforementioned methods. Further, values of Re/d and NZ factors of the phase difference films 4Q were measured.

### Example 5

(5-1. Triblock Copolymer)

A triblock copolymer P5 was obtained as a lump-shape product by the same manner as that of Example 1 (1-1. Triblock copolymer) except for the following matters.
In the reaction of (first stage), 10.3 parts of 2-vinylnaphthalene was added as the monomer (a).
The amount of n-butyllithium was changed from 0.03 part to 0.04 part.
In the reaction of (second stage), 15.4 parts of butadiene was added as the monomer (b).
In the reaction of (third stage), 10.3 parts of 2-vinylnaphthalene was added as the monomer (a).

The triblock copolymer P5 has a block configuration of (block (A))-(block (B))-(block (A)). In the triblock copolymer P5, the block (A) was a 2-vinylnaphthalene block and the block (B) was a hydrogenated butadiene block.

The obtained triblock copolymer P5 was analyzed by ¹H-NMR. As a result, the weight ratio of the 2-vinylnaphthalene unit as the polymerization unit A relative to the hydrogenated butadiene unit as the polymerization unit B in the triblock copolymer was 57:43, and thus, the weight fraction of the polymerization unit A was 57%. The hydrogenation rate of the 2-vinylnaphthalene unit was 0%, and the hydrogenation rate of the butadiene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (butadiene unit) relative to the polymerization unit B (hydrogenated butadiene unit) was 1/99. The weight-average molecular weight of the triblock copolymer P5 measured by GPC was 80000. The glass transition temperature of the triblock copolymer P5 measured by TMA was 125° C. The intrinsic birefringence value of the triblock copolymer P5 is negative.

(5-2. Pre-Stretch Film)

A pre-stretch film 5 was obtained by the same manner as that of Example 1 (1-2. Pre-stretch film) except for the following matter.
The triblock copolymer P5 was used instead of the triblock copolymer P1 as the resin C.

For the obtained pre-stretch film 5, the phase structure was observed by irradiation of the cross section with X-ray by the small-angle X-ray scattering method under the aforementioned conditions. As a result, a lamellar structure was observed. The distance between phases was 40 nm. Furthermore, a cut piece of a cross section parallel to the thickness direction was prepared and observed by TEM. As a result, a lamella-shaped phase separation structure was confirmed.

The Rth/d of the obtained pre-stretch film 5 was measured. The result was Rth/d=7.1×10⁻³.

(5-3. Phase Difference Film (λ/4 Plate))

Three types of phase difference films 5Q with a thickness of 55 to 70 μm were obtained by the same manner as that of Example 1 (1-3. Phase difference film (λ/4 plate)) except for the following matters.
The pre-stretch film 5 was used instead of the pre-stretch film 1.
The stretching temperature was changed to 135° C. Using the obtained three types of the phase difference films 5Q, the viewing angle properties were evaluated by the aforementioned methods. Further, values of Re/d and NZ factors of the phase difference films 5Q were measured.

### Example 6

(6-1. Triblock Copolymer)

A triblock copolymer P6 was obtained as a lump-shape product by the same manner as that of Example 1 (1-1. Triblock copolymer) except for the following matters.
In the reaction of (first stage), 14.4 parts of 2-vinylnaphthalene was added as the monomer (a).
The amount of n-butyllithium was changed from 0.03 part to 0.04 part.
In the reaction of (second stage), 7.2 parts of isoprene was added instead of 11.9 parts of butadiene as the monomer (b).
In the reaction of (third stage), 14.4 parts of 2-vinylnaphthalene was added as the monomer (a).

The triblock copolymer P6 has a block configuration of (block (A))-(block (B))-(block (A)). In the triblock copolymer P6, the block (A) was a 2-vinylnaphthalene block and the block (B) was a hydrogenated isoprene block.

The obtained triblock copolymer P6 was analyzed by ¹H-NMR. As a result, the weight ratio of the 2-vinylnaphthalene unit as the polymerization unit A relative to the hydrogenated isoprene unit as the polymerization unit B in the triblock copolymer was 80:20, and thus, the weight fraction of the polymerization unit A was 80%. The hydrogenation rate of the 2-vinylnaphthalene unit was 0%, and the hydrogenation rate of the isoprene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (isoprene unit) relative to the polymerization unit B (hydrogenated isoprene unit) was 1/99. The weight-average molecular weight of the triblock copolymer P6 measured by GPC was 70000. The glass transition temperature of the triblock copolymer P6 measured by TMA was 143° C. The intrinsic birefringence value of the triblock copolymer P6 is negative.

(6-2. Pre-Stretch Film)

A pre-stretch film 6 was obtained by the same manner as that of Example 1 (1-2. Pre-stretch film) except for the following matter.
The triblock copolymer P6 was used as the resin C instead of the triblock copolymer P1.

For the obtained pre-stretch film 6, the phase structure was observed by irradiation of the cross section with X-ray by the small-angle X-ray scattering method under the aforementioned conditions. As a result, a cylinder structure was observed. The distance between phases was 40 nm. Furthermore, a cut piece of a cross section parallel to the thickness direction was prepared and observed by TEM. As a result, a cylinder-shape phase separation structure was confirmed.

The Rth/d of the obtained pre-stretch film 6 was measured. The result was Rth/d=2.5×10⁻³.

(6-3. Phase Difference Film (λ/4 Plate))

Three types of phase difference films 6Q with a thickness of 60 to 80 μm was obtained by the same manner as that of Example 1 (1-3. Phase difference film (λ/4 plate)) except for the following matters.
The pre-stretch film 6 was used instead of the pre-stretch film 1.
The stretching temperature was changed to 153° C.

Using the obtained three types of the phase difference films 6Q, the viewing angle properties were evaluated by the aforementioned methods. Further, values of Re/d and NZ factors of the phase difference films 6Q were measured.

### Example 7

(7-1. Triblock Copolymer)

A triblock copolymer P7 was obtained as a lump-shape product by the same manner as that of Example 1 (1-1. Triblock copolymer) except for the following matters.
In the reaction of (first stage), 10.3 parts of 2-vinylnaphthalene was added as the monomer (a).
The amount of n-butyllithium was changed from 0.03 part to 0.04 part.
In the reaction of (second stage), 15.4 parts of isoprene was added instead of 11.9 parts of butadiene as the monomer (b).
In the reaction of (third stage), 10.3 parts of 2-vinylnaphthalene was added as the monomer (a).

The triblock copolymer P7 has a block configuration of (block (A))-(block (B))-(block (A)). In the triblock copolymer P7, the block (A) was a 2-vinylnaphthalene block and the block (B) was a hydrogenated isoprene block.

The obtained triblock copolymer P7 was analyzed by ¹H-NMR. As a result, the weight ratio of the 2-vinylnaphthalene unit as the polymerization unit A relative to the hydrogenated isoprene unit as the polymerization unit B in the triblock copolymer was 57:43. Thus, the weight fraction of the polymerization unit A was 57%. The hydrogenation rate of the 2-vinylnaphthalene unit was 0%, and the hydrogenation rate of the isoprene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (isoprene unit) relative to the polymerization unit B (hydrogenated isoprene unit) was 1/99. The weight-average molecular weight of the triblock copolymer P7 measured by GPC was 85000. The glass transition temperature of the triblock copolymer P7 measured by TMA was 125° C. The intrinsic birefringence value of the triblock copolymer P7 is negative.

(7-2. Pre-Stretch Film)

A pre-stretch film 7 was produced by the same manner as that of Example 1 (1-2. Pre-stretch film) except for the following matter.
The triblock copolymer P7 was used as the resin C instead of the triblock copolymer P1.

For the obtained pre-stretch film 7, the phase structure was observed by irradiation of the cross section with X-ray by the small-angle X-ray scattering method under the aforementioned conditions. As a result, a lamellar structure was observed. The distance between phases was 45 nm. Furthermore, a cut piece of a cross section parallel to the thickness direction was prepared and observed by TEM. As a result, a lamella-shaped phase separation structure was confirmed.

The Rth/d of the obtained pre-stretch film 7 was measured. The result was Rth/d=8.1×10⁻³.

(7-3. Phase Difference Film (λ/4 Plate))

Three types of phase difference films 7Q with a thickness of 55 to 70 μm were obtained by the same manner as that of Example 1 (1-3. Phase difference film (λ/4 plate)) except for the following matters.
The pre-stretch film 7 was used instead of the pre-stretch film 1.
The stretching temperature was changed to 135° C.

Using the obtained three types of the phase difference films 7Q, the viewing angle properties were evaluated by the aforementioned methods. Further, values of Re/d and NZ factors of the phase difference films 7Q were measured.

### Comparative Example 1

(C1-1. Triblock Copolymer)

A triblock copolymer CP1 was obtained as a lump-shape product by the same manner as that of Example 1 (1-1. Triblock copolymer) except for the following matters.
In the reaction of (first stage), 13.0 parts of 2-vinylnaphthalene was added as the monomer (a).
In the reaction of (second stage), 10.1 parts of isoprene was added instead of 11.9 parts of butadiene as the monomer (b).
In the reaction of (third stage), 13.0 parts of 2-vinylnaphthalene was added as the monomer (a).

The triblock copolymer CP1 has a block configuration of (block (A))-(block (B))-(block (A)). In the triblock copolymer CP1, the block (A) was a 2-vinylnaphthalene block and the block (B) was a hydrogenated isoprene block.

The obtained triblock copolymer CP1 was analyzed by ¹H-NMR. As a result, the weight ratio of the 2-vinylnaphthalene unit as the polymerization unit A relative to the hydrogenated isoprene unit as the polymerization unit B in the triblock copolymer was 72:28, and thus, the weight fraction of the polymerization unit A was 72%. The hydrogenation rate of the 2-vinylnaphthalene unit was 0%, and the hydrogenation rate of the isoprene unit was 99%. That is, the molar ratio of the polymerization unit HA (hydrogenated 2-vinylnaphthalene unit) relative to the polymerization unit A (2-vinylnaphthalene unit) was 0, and the molar ratio of the polymerization unit B′ (B′-1 and B′-2) (isoprene unit) relative to the polymerization unit B (hydrogenated isoprene unit) was 1/99. The weight-average molecular weight of the triblock copolymer CP1 measured by GPC was 120000. The glass transition temperature of the triblock copolymer CP1 measured by TMA was 140° C. The intrinsic birefringence value of the triblock copolymer CP1 is negative.

(C1-2. Pre-Stretch Film)

A pre-stretch film C1 was obtained by the same manner as that of Example 2 (2-2. Pre-stretch film) except for the following matter.
The triblock copolymer CP1 was used as the resin C.
The temperature of the cooling roll was set at 110° C.
The screw rotation speed of the extruder was set at 150 to 200 rpm.

For the obtained pre-stretch film C1, the phase structure was observed by irradiation of the cross section with X-ray by the small-angle X-ray scattering method under the aforementioned conditions. As a result, the obtained scattering pattern was unclear, and fitting to a theoretical curve was impossible. Furthermore, a cut piece of a cross section parallel to the thickness direction was prepared and observed by TEM. As a result, a cylinder structure with random size and dimensions was observed.

The Rth/d of the obtained pre-stretch film C1 was measured. The result was Rth/d=1.4×10⁻³.

(C1-3. Phase Difference Film (λ/4 Plate))

Three types of phase difference films C1Q with a thickness of 50 to 70 μm were obtained by the same manner as that of Example 1 (1-3. Phase difference film (λ/4 plate)) except for the following matters.
The pre-stretch film C1 was used instead of the pre-stretch film 1.
The stretching temperature was changed to 150° C.

Using the obtained three types of the phase difference films C1Q, the viewing angle properties were evaluated by the aforementioned methods. Further, values of Re/d and NZ factors of the phase difference films C1Q were measured.

### Comparative Example 2

(C2-1. Homopolymer of Monomer (a))

Into a pressure resistant reaction vessel dried and purged with a nitrogen gas, 500 parts of toluene as a solvent and 0.03 part of n-butyl lithium as a polymerization catalyst were charged. After that, 36 parts of 2-vinylnaphthalene was added as the monomer (a). The mixture was reacted at 25° C. for 2 hour for performing the polymerization reaction. As a result, a polymer HP(A) was obtained in the reaction mixture. The reaction mixture was poured into a large amount of 2-propanol to thereby cause precipitation of the polymer HP(A), which was then isolated.

The obtained polymer HP(A) was analyzed by ¹H-NMR. As a result, the polymer HP(A) was formed only of a 2-vinylnaphthalene unit. Thus, the weight fraction of the polymerization unit A in the polymer HP(A) was 100%. The weight-average molecular weight of the polymer HP(A) measured by GPC was 100000. The glass transition temperature of the polymer HP(A) measured by TMA was 145° C. The glass transition temperature of the polymer HP(A) measured by DSC was 150° C. The refractive index was 1.67.

(C2-2. Pre-Stretch Film)

A pre-stretch film C2 was produced by the same manner as that of Example 1 (1-2. Pre-stretch film) except for the following matters.
The polymer HP(A) was used as the resin C instead of the triblock copolymer P1.
Pressing temperature was set to 200° C.

For the obtained pre-stretch film C2, the phase structure was observed by irradiation of the cross section with X-ray by the small-angle X-ray scattering method under the aforementioned conditions. As a result, phase separation structure was not observed. Furthermore, a cut piece of a cross section parallel to the thickness direction was prepared and observed by TEM. As a result, phase separation structure was not confirmed.

The Rth/d of the obtained pre-stretch film C2 was measured. The result was Rth/d=0.1×10⁻³.

(C2-3. Phase Difference Film (λ/4 Plate))

A phase difference film C2Q with a thickness of 80 was obtained by the same manner as that of Example 1 (1-3. Phase difference film (λ/4 plate)) except for the following matters. Those of stretching ratios of 3.0 times and 4.0 times were unable to be produced as breakage occurred in the stretching process.
The phase difference film C2 was used instead of the pre-stretch film 1.
The stretching temperature was changed to 155° C.

Using the obtained phase difference film C2Q, the viewing angle properties were evaluated by the aforementioned methods. Further, values of Re/d and NZ factor of the phase difference film C2Q were measured.

### Comparative Example 3

(C3-1. Triblock Copolymer)

(First Stage)

Into a reaction vessel equipped with a stirrer, which had been sufficiently replaced with a nitrogen gas, 395 parts of dehydrated cyclohexane, 34.5 parts of dehydrated styrene, and 0.65 part of n-butyl ether were charged. Under stirring at 60° C., 0.87 part of n-butyl lithium (15% n-hexane solution) was added to initiate polymerization. The polymerization reaction was continued for 60 minutes.

(Second Stage)

Subsequently, 61.1 parts of dehydrated isoprene was added, and the mixture was continuously stirred for 40 minutes.

(Third Stage)

After that, 34.5 parts of dehydrated styrene was added under stirring at 60° C. and reacted for 60 minutes. The polymerization conversion rate at this point was almost 100%. Then, 0.2 part of methanol was added to terminate the reaction. As a result, a triblock copolymer CP3 having a block configuration of (styrene block)-(isoprene block)-(styrene block) was obtained in the reaction mixture.

The obtained triblock copolymer CP3 was analyzed by ¹H-NMR. As a result, the weight ratio of the styrene unit as the polymerization unit A relative to the isoprene unit as the polymerization unit B′ in the triblock copolymer was 53:47, and thus, the weight fraction of the polymerization unit A was 53%. The weight-average molecular weight of the triblock copolymer CP3 measured by GPC was 90000. The glass transition temperature of the triblock copolymer CP3 measured by TMA was 79° C. The intrinsic birefringence value of the triblock copolymer CP3 is positive.

(C3-2. Pre-Stretch Film)

A pre-stretch film C3 was obtained by the same manner as that of Example 1 (1-2. Pre-stretch film) except for the following matters.
The triblock copolymer CP3 was used as the resin C instead of the triblock copolymer P1.
Pressing temperature was set to 180° C.

For the obtained pre-stretch film C3, the phase structure was observed by irradiation of the cross section with X-ray by the small-angle X-ray scattering method under the aforementioned conditions. As a result, a lamellar structure was observed. The distance between phases was 45 nm. Furthermore, a cut piece of a cross section parallel to the thickness direction was prepared and observed by TEM. As a result, a lamella-shaped phase separation structure was confirmed.

The Rth/d of the obtained pre-stretch film C3 was measured. The result was Rth/d=2.3×10⁻³.

(C3-3. Phase Difference Film (λ/4 Plate))

Three types of phase difference films C3Q with a thickness of 50 to 70 μm were obtained by the same manner as that of Example 1 (1-3. Phase difference film (λ/4 plate)) except for the following matters.
The pre-stretch film C3 was used instead of the pre-stretch film 1.
The stretching temperature was changed to 89° C.

Using the obtained three types of the phase difference films C3Q, the viewing angle properties were evaluated by the aforementioned methods. Further, values of Re/d and NZ factors of the phase difference films C3Q were measured.

### Reference Example 1

(Hydrogenated Product of Isoprene Homopolymer)

Into a reaction vessel equipped with a stirrer, which had been sufficiently replaced with a nitrogen gas, 395 parts of dehydrated cyclohexane, 120 parts of dehydrated isoprene, and 0.77 part of n-butyl ether were charged. Under stirring at 50° C., 1.25 parts of n-butyl lithium (15% n-hexane solution) was added to initiate polymerization. The polymerization reaction was continued for 60 minutes. The polymerization conversion rate at this point was almost 100%. Then, 0.2 part of methanol was added to terminate the reaction. A part of the obtained polymer solution was extracted and dried to obtain a homopolymer of isoprene. The obtained homopolymer of isoprene had a molecular weight distribution (Mw/Mn) of 1.07 and a weight-average molecular weight (Mw) of 76000.

The obtained polymer solution was transferred into a pressure resistant reaction vessel equipped with a stirrer. To the polymer solution, 1.5 parts of a silica-alumina supported nickel catalyst (product name: T-8400RL, manufactured by Clariant Catalysts K.K., nickel containing amount 33%) as a hydrogenation catalyst and 100 parts of dehydrated cyclohexane were added and mixed. The reaction vessel was replaced with a hydrogen gas in a normal temperature state, and the temperature was increased to 170° C. in a state of being pressurized at a gauge pressure of 2 MPa. When the inside temperature of the pressure resistance reaction vessel reached 170° C., the hydrogen pressure was increased to 4.5 MPa, and a hydrogenation reaction was performed for 12 hours (hydrogenation rate: 99.9%). The resulting solution after hydrogenation was dried to obtain a hydrogenated product of a homopolymer of isoprene HIp. The glass transition temperature of the hydrogenated product HIp measured by DSC was −60° C. The refractive index was 1.48.

### Reference Example 2

(Hydrogenated Product of Butadiene Homopolymer)

Into a reaction vessel equipped with a stirrer, which had been sufficiently replaced with a nitrogen gas, 395 parts of dehydrated cyclohexane, 120 parts of butadiene, and 0.77 part of n-butyl ether were charged. Under stirring at 20° C., 1.25 parts of n-butyl lithium (15% n-hexanoic solution) was added to initiate polymerization. The polymerization reaction was continued for 60 minutes. The polymerization conversion rate at this point was almost 100%. Then, 0.2 part of methanol was added to terminate the reaction. A part of the obtained polymer solution was extracted and dried to obtain a homopolymer of butadiene. The obtained homopolymer of butadiene had a molecular weight distribution (Mw/Mn) of 1.27 and a weight-average molecular weight (Mw) of 96000.

The obtained polymer solution was transferred into a pressure resistant reaction vessel equipped with a stirrer. To the polymer solution, 1.5 parts of a silica-alumina supported nickel catalyst (product name: T-8400RL, manufactured by Clariant Catalysts K.K., nickel containing amount 33%) as a hydrogenation catalyst and 100 parts of dehydrated cyclohexane were added and mixed. The reaction vessel was replaced with a hydrogen gas in a normal temperature state, and the temperature was increased to 170° C. in a state of being pressurized at a gauge pressure of 2 MPa. When the inside temperature of the pressure resistance reaction vessel reached 170° C., the hydrogen pressure was increased to 4.5 MPa, and a hydrogenation reaction was performed for 12 hours (hydrogenation rate: 99.9%). The resulting solution after hydrogenation was dried to obtain a hydrogenated product of a homopolymer of butadiene HBt. The glass transition temperature of the hydrogenated product HBt measured by DSC was −50° C. The refractive index was 1.51.

The results of Examples and Comparative Examples are shown in the following tables.

Meanings of the abbreviations in the following tables are as follows.

VN: 2-vinylnaphthalene block

St: styrene block

B: hydrogenated butadiene block

Ip: hydrogenated isoprene block

DIp: isoprene block

NZ factor: NZ factor of the phase difference film

Weight fraction (A): weight fraction (%) of 2-vinylnaphthalene unit or styrene unit

The values of Rth/d*10⁻³ are those measured for the pre-stretch films. The values of Re/d*10⁻³ are the minimum values among the values measured for the phase difference films produced with the stretching ratios of 2.0 times, 3.0 times and 4.0 times. The NZ factors are the averages of the values measured for the phase difference films produced with the stretching ratios of 2.0 times, 3.0 times and 4.0 times. As to Comparative Example 2, the value is the value measured for the phase difference film produced with the stretching ratio of 2.0 times.

TABLE 1

| | | Phase | Weight | | Molding | | | | Viewing |
|---|---|---|---|---|---|---|---|---|---|
| | | separation | fraction | Molding | temperature | Rth/d | Re/d | NZ | angle |
| | Resin C | structure | (A) (%) | method | (° C.) | (*10⁻³) | (*10⁻³) | factor | property |
| Ex. 1 | VN-B-VN | Yes | 67 | Press | 270 | 6.0 | 2.0 | 0.5 | Excellent |
| Ex. 2 | VN-Ip-VN | Yes | 67 | Extrusion | 270 | 4.6 | 2.0 | 0.5 | Excellent |
| Ex. 3 | VN-Ip-VN | Yes | 67 | Press | 270 | 3.7 | 2.0 | 0.5 | Excellent |
| Ex. 4 | VN-Ip-VN | Yes | 75 | Press | 270 | 3.2 | 1.5 | 0.4 | Good |
| Ex. 5 | VN-B-VN | Yes | 57 | Press | 270 | 7.1 | 2.0 | 0.7 | Good |
| Ex. 6 | VN-Ip-VN | Yes | 80 | Press | 270 | 2.5 | 1.5 | 0.2 | Good |
| Ex. 7 | VN-Ip-VN | Yes | 57 | Press | 270 | 8.1 | 2.0 | 0.8 | Good |
| Comp. | VN-Ip-VN | Yes | 72 | Extrusion | 270 | 1.4 | 2.0 | 0 | Poor |
| Ex. 1 | | | | | | | | | |
| Comp. | VN | No | 100 | Press | 200 | 0.1 | 1.5 | 0 | Poor |
| Ex. 2 | | | | | | | | | |
| Comp. | St-DIp-St | Yes | 53 | Press | 180 | 2.3 | 2.0 | 1.0 | Poor |
| Ex. 3 | | | | | | | | | |

From the aforementioned results, the following matters are found.

It is found that, from the optical film of Comparative Example 1 having an Rth/d value of less than 2.5×10⁻³, a phase difference film having an average NZ factor of 0 and poor viewing angle properties is produced. It is also found that, from the optical film of Comparative Example 2 in which phase separation structure is not developed and the Rth/d value of which is less than 2.5×10⁻³, a phase difference film having an average NZ factor of 0 and poor viewing angle properties is produced. It is also found that, from the optical film of Comparative Example 3 having an Rth/d value of less than 2.5×10⁻³, a phase difference film having an average NZ factor of 1.0 or more and poor viewing angle properties is produced.

On the contrary, it is found that, from the optical film of Examples in which phase separation structure is developed and the Rth/d value of which is 2.5×10⁻³ or more, phase difference films having an average NZ factor of more than 0 and less than 1 and also having a good viewing angle properties can be produced with a range of stretching ratio that is as large as 2 to 4 times.

From the aforementioned results, it is found that, with the optical film of the present invention, a phase difference film that brings about sufficient viewing angle compensation effect can be produced at a low cost.

1. An optical film formed of a resin C including a copolymer P containing a polymerization unit A and a polymerization unit B, wherein
the optical film includes a phase separation structure that expresses structural birefringence,
the phase separation structure includes a phase containing as a main component the polymerization unit A and a phase containing as a main component the polymerization unit B, and
a value of Rth/d calculated from the thickness-direction retardation Rth (nm) and thickness d (nm) is 2.5×10⁻³ or more.

2. The optical film according to claim 1, wherein the value of Rth/d is 3.0×10⁻³ or more and 8.0×10⁻³ or less.

3. The optical film according to claim 1, wherein the thickness d is 150 μm or less.

4. The optical film according to claim 1, wherein the phase separation structure has a configuration of any of lamella, cylinder, and spheroid.

5. The optical film according to claim 1, wherein a distance between phases in the phase separation structure is 200 nm or less.

6. The optical film according to claim 1, wherein the copolymer P is a block copolymer having a block (A) containing as a main component the polymerization unit A and a block (B) containing as a main component the polymerization unit B.

7. The optical film according to claim 1, wherein the polymerization unit A is a unit represented by the following general formula (A): 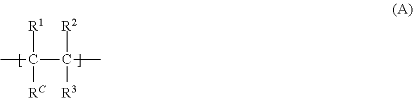
in the formula, R^{C} is a group selected from the group consisting of a phenyl group, a biphenylyl group, a naphthyl group, an anthracenyl group, a phenanthrenyl group, a naphthacenyl group, a pentacenyl group, and a terphenylyl group, and
R¹ to R³ are each independently one selected from the group consisting of a hydrogen atom and an alkyl group of 1 to 12 carbon atoms.

8. The optical film according to claim 7, wherein a molar ratio of a polymerization unit HA, which is a hydrogenation product of the polymerization unit A, relative to the polymerization unit A in the copolymer P is 0/100 or more and 10/90 or less.

9. The optical film according to claim 1, wherein the polymerization unit B is a unit represented by the general formula (B-1) or a unit represented by the general formula (B-2): 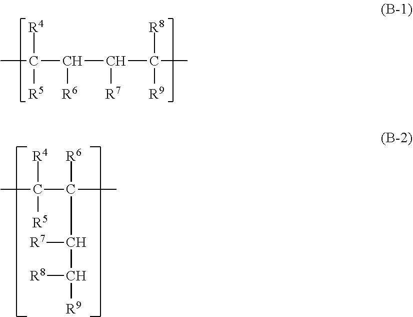
in the formula, R⁴ to R⁹ are each independently one selected from the group consisting of a hydrogen atom and an alkyl group of 1 to 6 carbon atoms.

10. The optical film according to claim 9, wherein a total molar ratio of a unit represented by the following general formula (B′-1) and a unit represented by the following general formula (B′-2) relative to the polymerization unit B in the copolymer P is 0/100 or more and 10/90 or less: 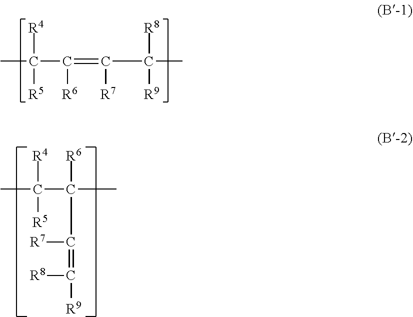
in the formula, R⁴ to R⁹ are the same definitions as those described above.

11. The optical film according to claim 1, wherein
the polymerization unit A is a vinylnaphthalene unit, a vinylnaphthalene derivative unit, a styrene unit, or a styrene derivative unit, and
the polymerization unit B is a unit that is a hydrogenation product of an isoprene unit, a unit that is a hydrogenation product of a butadiene unit, a unit that is a hydrogenation product of a 1,3-pentadiene unit, a unit that is a hydrogenation product of a 2,3-dimethyl-1,3-butadiene unit, a unit that is a hydrogenation product of a 1,3-hexadiene unit, a unit that is a hydrogenation product of a 2-methyl-1,3-pentadiene unit, a unit that is a hydrogenation product of a 3-methyl-1,3-pentadiene unit, or a unit that is a hydrogenation product of a 2,4-dimethyl-1,3-pentadiene unit.

12. The optical film according to claim 1, wherein
the copolymer P includes a triblock copolymer P′, and
the triblock copolymer P′ is a triblock copolymer of (A)-(B)-(A) having a block (A) containing as a main component the polymerization unit A and a block (B) containing as a main component the polymerization unit B.

13. The optical film according to claim 1, wherein the copolymer P has a negative intrinsic birefringence value.

14. The optical film according to claim 1, wherein the polymerization unit A has a negative intrinsic birefringence value, and the polymerization unit B has a positive intrinsic birefringence value.

15. The optical film according to claim 1, wherein a weight fraction of the polymerization unit A in the copolymer P is 55% by weight or more and 75% by weight or less.

16. A method for producing the optical film according to claim 1, comprising the steps of:
heating the resin C at 150° C. or higher to form a single-layer film of the resin C; and
causing phase-separation of the resin C in the film.

17. The method for producing the optical film according to claim 16, wherein the step of forming the film includes a step of press-molding the resin C.

18. The method for producing the optical film according to claim 16, wherein the step of forming the film includes melt-extruding a single layer of the resin C.

19. A method for producing a phase difference film comprising the step of stretching the optical film according to claim 1 to obtain a phase difference film, a value of Re(E)/d(E) calculated from the in-plane retardation Re(E) (nm) and thickness d(E) (nm) of the phase difference film being 1.5×10⁻³ or more.

20. The method for producing a phase difference film according to claim 19, wherein the optical film is produced by the method for producing the optical film including the steps of:
heating the resin C at 150° C. or higher to form a single-layer film of the resin C; and
causing phase-separation of the resin C in the film.
